(19) United States
(12) Patent Application Publication
(10) Pub. No.: US 2026/0224932 A1
(43) Pub. Date: Aug. 6, 2026

(54) TRANSPORT DEVICE AND A METHOD OF INSTALLING TANKS TO A FIRE SUPPRESSION SYSTEM USING THE TRANSPORT DEVICE

(71) Applicant: KIDDE-FENWAL, LLC, Ashland, MA (US)

(72) Inventor: Karen Bouchard, Ashland, MA (US)

(73) Assignee: Kidde-Fenwal, LLC, Ashland, MA (US)

(21) Appl. No.: 19/046,816

(22) Filed: Feb. 6, 2025

(51) Int. Cl. A62C 35/02

(52) U.S. Cl. CPC A62C 35/023

(57) ABSTRACT

A transport device and a method for transporting tanks to a fire suppression system and installing tanks to a fire suppression system is provided. The transport device includes a base; a frame mounted to the base; and a holder assembly mounted to the frame, wherein the transport device is configured to be moved by a forklift or a hoist so as to transport the tanks to the fire suppression system as a single unit and facilitate the coupling of the tanks to the fire suppression system.

### TECHNICAL FIELD

This disclosure relates to a transport device for transporting a plurality of tanks and a method for installing the plurality of tanks to a fire suppression system.

### BACKGROUND

The installation of a fire suppression system includes a plurality of tanks coupled to a plurality of discharge nozzles and a control system and a monitoring system. The tanks are pressurized and include a fire suppressant. The tanks are fluidly couple to the discharge nozzles via a manifold. The manifold includes a plurality of intake lines configured to be coupled to a corresponding one of the tanks via a respective discharge valve.

The monitoring system is configured to detect a fire and a location of the fire. The control system is configured to selectively open one or more discharge nozzles and discharge valves so as to release the fire suppressant and put out the fire.

When the tanks are replaced, the distributor provides the tanks on pallets. Typically, the larger sized tanks are laid on their sides and stacked. Thus, when transported to the location of the fire suppression system, the tanks are individually unloaded and positioned to be attached to a respective intake line. This requires offloading the tanks from the pallet, positioning the tanks from a horizontal to an upright position, and moving the tanks individually from the pallet to the location of the manifold.

Accordingly, it remains desirable to have a transport device and a method of transporting a plurality of tanks that facilitates the installation of the tanks to a fire suppression system. Further, it remains desirable to have a transportation device that reduces the physical requirements of installing tanks to the fire suppression system relative to the prior art. Further, it is desirable to have a transportation device that simplifies the installation of tanks to the fire suppression system by eliminating the steps of positioning the tanks from a horizontal position in a pallet to an upright position for installation.

### SUMMARY

The disclosure relates to a transport device configured for transporting at least one tank. The transport device includes a base, a frame mounted to the base, and a holder assembly mounted to the frame. The base includes a support wall spaced apart from a bottom wall to define an opening configured to receive a fork of a forklift. The support wall is configured to support the at least one tank, and the holder assembly is configured to hold the at least one tank to the frame.

A method of assembling a shipment including a plurality of tanks is also disclosed. The method involves providing a transport device with a base, a frame mounted to the base, and a holder assembly mounted to the frame. The base includes a support wall spaced apart from a bottom wall to define an opening. The support wall is configured to support the at least one tank, and the holder assembly is configured to hold the at least one tank to the frame. The method includes mounting the plurality of tanks onto the base, securing each of the plurality of tanks onto the frame using the holder assembly, and transporting the transport device with the plurality of tanks onto a shipping vessel.

Additionally, a method of installing a plurality of tanks to a fire suppression system is disclosed. The fire suppression system includes a nozzle for discharging a fire suppressant medium and a manifold fluidly connected to the nozzle. The manifold has a plurality of intake lines configured to be coupled to a corresponding one of the plurality of tanks. The method involves providing a transport device with a base, a frame mounted to the base, and a holder assembly mounted to the frame. The base includes a support wall spaced apart from a bottom wall to define an opening. The support wall is configured to support the at least one tank, and the holder assembly is configured to hold the at least one tank to the frame. The method includes mounting the plurality of tanks onto the base, securing each of the plurality of tanks onto the frame using the holder assembly, transporting the transport device with the plurality of tanks onto a shipping vessel, transporting the shipping vessel to a location where the fire suppression system is housed, offloading the transport device from the shipping vessel at the location, positioning the transport device adjacent to the manifold, and coupling the plurality of intake lines to the corresponding one of the plurality of tanks as the plurality of tanks are held by the transport device.

In some implementations, the bottom wall includes a first elongated member, and a second elongated member coupled together to form a cross-shape.

In some examples, the frame includes a pair of upright legs spaced apart from each other, and a cross-member extending between the pair of upright legs, with the holder assembly mounted to the cross-member.

The transport device may further include a ramp disposed adjacent to the base.

Optionally, the base and the frame are formed of steel and/or a steel composite.

In some implementations, the base further includes bolster blocks disposed between the support wall and the bottom wall.

In some examples, the cross-member is a pair of cross-members, each having a plurality of slots, with the holder assembly attached to one of the plurality of slots.

The frame may include a plurality of hoist members, each having a catch configured to be coupled to a hoist.

Optionally, the catch is a closed loop.

In some implementations, the plurality of hoist members is four hoist members, each fixed to a corresponding corner of the base.

In some examples, the frame includes a plurality of lateral support members connecting the plurality of hoist members to each other.

The catch may be four catches, each disposed on a top end of a corresponding one of the plurality of hoist members.

In some implementations, the method of assembling a shipment further includes providing a forklift having a fork and inserting the fork into the opening of the base to transport the transport device with the plurality of tanks onto a shipping vessel using the forklift.

In some examples, the method of assembling a shipment further includes providing a hoist, coupling the hoist to the catch, and transporting the transport device with the plurality of tanks onto a shipping vessel using the hoist.

The method of installing a plurality of tanks to a fire suppression system may further include providing a forklift having a fork and inserting the fork into the opening of the base to position the transport device adjacent the manifold.

Optionally, the method of installing a plurality of tanks to a fire suppression system further includes providing a hoist, coupling the hoist to the catch, and using the hoist to position the transport device adjacent the manifold.

Accordingly, a transport device and a method of transporting a plurality of tanks is provided which facilitates the installation of the tanks to a fire suppression system. Further, the transportation device reduces the physical requirements of installing tanks to the fire suppression system. Further, the transportation device simplifies the installation of tanks to the fire suppression system by eliminating the steps of positioning the tanks from a horizontal position in a pallet to an upright position for installation.

### DESCRIPTION OF DRAWINGS

FIG. 1 is a schematic view of a fire suppression system;

FIG. 2 is a perspective view of a transport device according to one aspect showing the transport device holding a plurality of tanks;

FIG. 3 is a view of FIG. 2 with the tanks removed;

FIG. 4 is a side view of the transport device shown in FIG. 2 with the holding assembly removed;

FIG. 5 is front view of FIG. 4;

FIG. 6 is an isolated view of a holder assembly;

FIG. 7 is a perspective view of FIG. 4 taken from the bottom;

FIG. 8 is a view of the transport device shown in FIG. 3 having a ramp;

FIG. 9 is a perspective view of a transport device according to a second aspect holding a plurality of tanks;

FIG. 10 is a perspective view of the transport device shown in FIG. 9 with the tanks removed.

FIG. 11 is a perspective view of the transport device shown in FIG. 10 with the holder assembly removed;

FIG. 12 is a perspective view of FIG. 11 taken from the bottom;

FIG. 13 is a diagram showing a method of assembling a shipment including a plurality of tanks;

FIG. 14 is a diagram showing a method of installing a plurality of tanks to a fire suppression system; and

FIG. 15 is a diagram showing a method of filling a plurality of tanks.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Directional terms as used herein-for example “up”, “down”, “right”, “left”, “front”, “back”, “top”, “bottom” are made only with reference to the figures as drawn and are not intended to imply absolute orientation. As such, terms such as “upper”, “lower”, “height” and “width” are taken in context of the directional terms and the drawings.

A transport device configured to transport a plurality of tanks from a distribution site to a fire suppression system is provided. The transport device includes a base, a frame mounted to the base, and a holder assembly mounted to the frame. The transport device is configured to hold the tanks in an upright position as to place the tanks in a position to readily couple with the fire suppression system. A method of assembling a shipment of tanks is also disclosed. The method involves providing the transport device and mounting the plurality of tanks onto the base, securing each of the plurality of tanks onto the frame using the holder assembly, and transporting the transport device with the plurality of tanks onto a shipping vessel. Wherein the tanks are provided to the site of the fire suppression system in a position to readily couple with the fire suppression system.

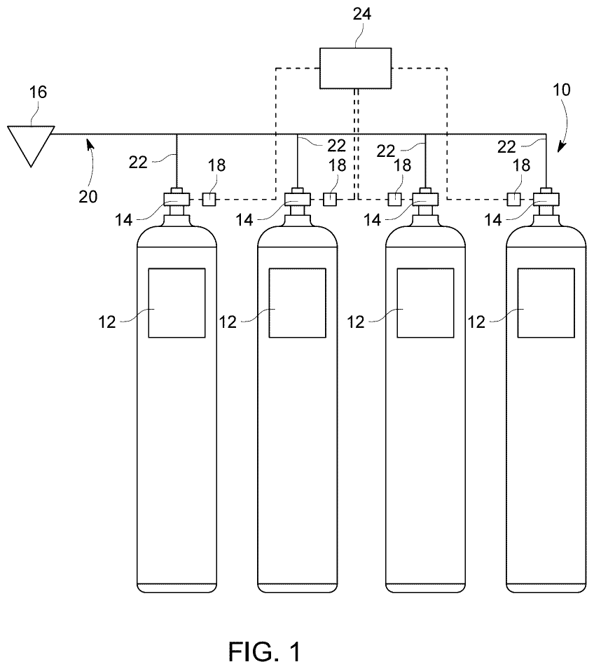

With reference now to FIG. 1, a fire suppression system 10 is provided. The fire prevention system includes a plurality of tanks 12 containing a fire suppressant. Each tank 12 includes a discharge valve 14 that is fluidly coupled to a plurality of discharge nozzles 16. A plurality of actuators 18 is operatively coupled to a corresponding one of the discharge nozzles 16. The tanks 12 are fluidly couple to the discharge nozzles 16 via a manifold 20. The manifold 20 includes a plurality of intake lines 22 configured to be coupled to a corresponding one of the tanks 12 via a respective discharge valve 14. It should be appreciated that the intake lines 22 may be any conduit currently known or later developed that is configured to manage the release of a fire suppressant under pressure. For instance, the intake lines 22 may be fixed piping, hoses, or a combination of both.

The fire suppression system 10 further includes a fire control panel 24. The fire control panel 24 is configured to detect a presence and location of a fire and sends a signal to the actuators 18 and discharge nozzle 16 so as to selectively open one or more discharge nozzles 16 and discharge valves 14, releasing the fire suppressant to put out the fire. FIG. 1 depicts the discharge nozzle 16 as being a singular unit; however, it should be appreciated that the fire suppression system 10 may include one or more discharge nozzles 16.

The tanks 12 are positioned in an upright manner so as to be able to couple with the manifold 20. The manifold 20 is laid out in a generally fixed position within a building. The tanks 12 are positioned adjacent the manifold 20. FIG. 1 depicts an aspect where there are four tanks 12 aligned in a row; however, it should be appreciated that the fire suppression system 10 may be configured to accommodate more or less tanks 12 than what is shown, and the tanks 12 may be arranged in a matrix illustratively including two-by-two, two-by-three, two-by-four, three-by-three or the like.

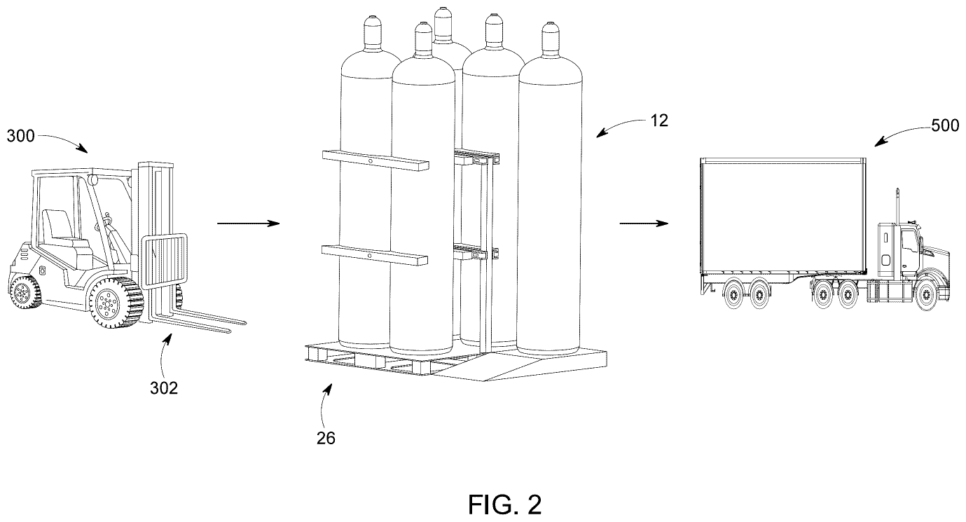

With reference now to FIG. 2, a depiction of a transport device 26 is provided. The transport device 26 is shown as dimension to accommodate four tanks 12 in a two-by-two configuration. However, it should be appreciated that the dimensions of the transport device 26 may accommodate more or less tanks 12 without deviating from the scope of the appended claims. The transport device 26 is configured to move the tanks 12 as a single unit. In one aspect, the transport device 26 is moved from a distribution cite via a forklift 300 to a shipping vessel 500 and transported to the fire suppression system 10. At the site of the fire suppression system 10, the transport device 26 is moved as a single unit from the shipping vessel 500 and placed adjacent to the manifold 20 so as to be positioned to be coupled to the respective intake line 22.

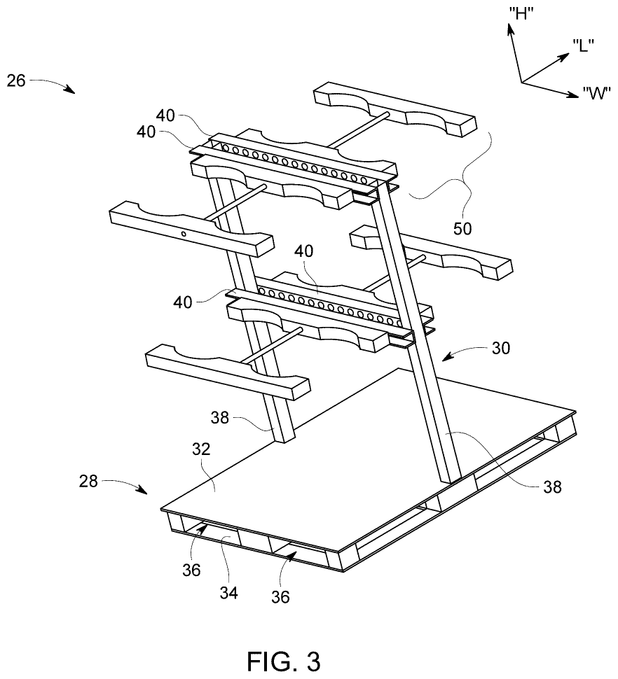

With reference now to FIGS. 3-5, the transport device 26 includes a base 28 and a frame 30. The base 28 and the frame 30 may be formed of a durable and rigid material such as steel or a steel alloy. The base 28 and the frame 30 may be coupled together by a weld or a conventional mounting means such as a bolt and screw. The base 28 includes a support wall 32 spaced apart from a bottom wall 34 so as to define an opening 36 configured to receive a forklift 300. In one aspect, the base 28 includes a pair of openings 36 configured to receive a fork 302 of the forklift 300, as indicated in FIG. 2.

The support wall 32 is configured to support the at least one tank 12. The support wall 32 and the bottom wall 34 are both generally planar members and is illustratively shown as having a length “L” that is greater than a width “W”. As shown, the support wall 32 has area configured to accommodate four tanks 12 in a two-by-two matrix. The tanks 12 are illustratively shown as five-hundred-pound/40-gallon tanks 12 having a diameter that is approximately 22 inches and height of approximately 79 inches, in which case the support wall 32 has a length of approximately 56 inches and a width of approximately 51 inches.

The frame 30 includes a includes a pair of upright legs 38 spaced apart from each other. The upright legs 38 are disposed along a periphery of and centered along a length of the support wall 32. The upright legs 38 are fixed to the support wall 32 and extend upwardly therefrom. The upright legs 38 are shown as being identical to each other and having a rectangular cross-section. However, it should be appreciated that the upright legs 38 may have a circular cross-section and may be hollowed out or solid in its body.

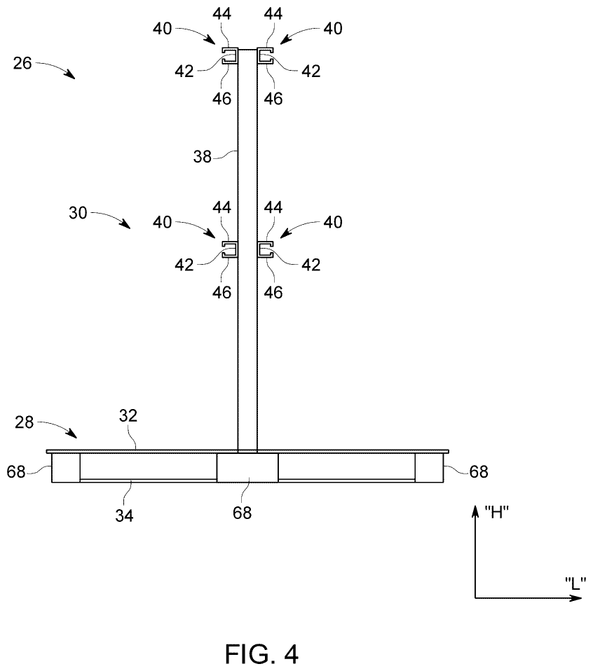

With reference again to FIG. 4, the frame 30 further includes a pair of a cross-members 40 extending between the pair of upright legs 38. In one aspect, the frame 30 includes an upper pair of cross-members 40 and a lower pair of the cross-members 40. Each of the cross-members 40 is a generally elongated members and may include a back wall 42, a top lip 44 and a bottom lip 46 connected to each other to form a U-shaped cross-section. The back wall 42 has a length configured to extend between the pair of upright legs 38. The back wall 42 may include a plurality of slots 48 which may be equally spaced apart from each other. The ends of the cross-members 40 are attached to a corresponding upright leg 38. In one aspect, the cross-members 40 are welded to the upright leg 38 and in another aspect, a bolt (not shown) may be inserted into a slot 48 that the overlays a corresponding upright leg 38.

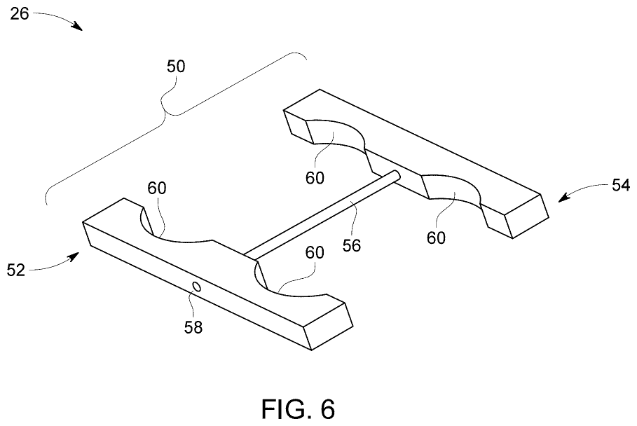

With reference now to FIG. 6, the transport device 26 may further include a holder assembly 50 mounted to the frame 30. The holder assembly 50 is configured to hold the tanks 12 to the frame 30 in an upright manner. The holder assembly 50 may include a first support member 52, a second support member 54 and a coupling bar 56 configured to couple the first support member 52 to the second support member 54. In one aspect, the coupling bar 56 is threaded on both ends and is configured to engage a threaded bore 58 centered within a corresponding first support member 52 and second support member 54, wherein rotation of the coupling bar 56 within a corresponding threaded bore 58 may pull the first support member 52 towards the second support member 54 so as to clamp the tanks 12 held therebetween as indicated by the bi-directional arrows.

With continued reference to FIG. 6 and again to FIGS. 2 and 3, the first support member 52 and the second support member 54 may be cuboidal members having a pair of concave surfaces 60 configured to abut in a symmetric manner with an outer surface of the tanks 12. The first support member 52 is configured to be attached to the cross-members 40. In one aspect, the first support member 52 may be configured to be seated against the back wall 42 of the cross-member 40 and between the top lip 44 and the bottom lip 46, so as to be held in a supported position. The first support members 52 and the second support members 54 are positioned so as to engage a bottom and top portion of a respective tank 12.

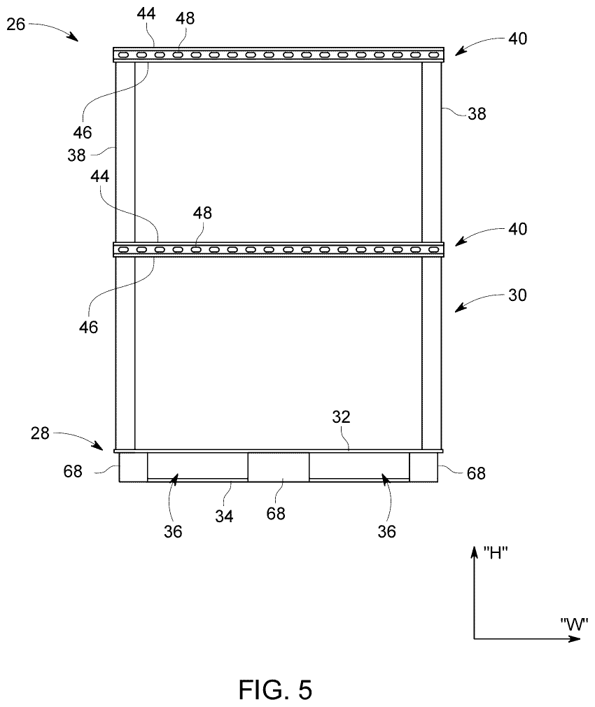

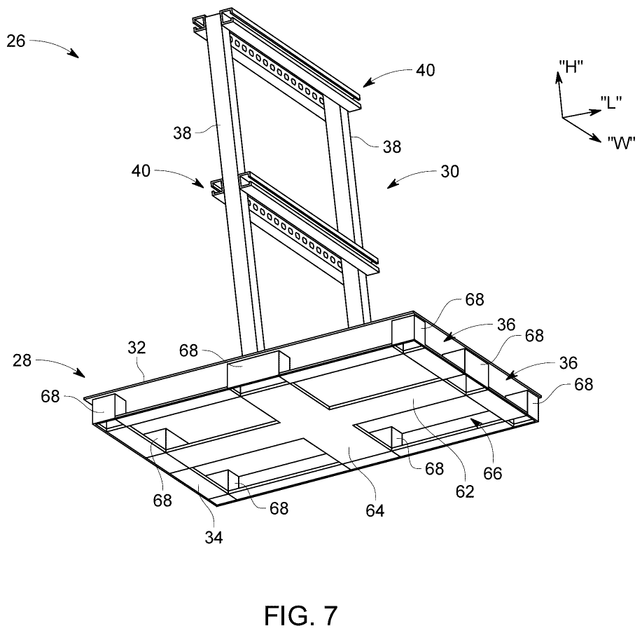

With reference again to FIGS. 4 and 5 and now to FIG. 7, the bottom wall 34 may be formed by a first elongated member 62 and a second elongated member 64 couped to together to form a cross-shape so as to form four bottom openings 66. In such an aspect, the base 28 further includes a plurality of bolster blocks 68 disposed between the support wall 32 and the bottom wall 34. For example, the base 28 includes eight (8) bolster blocks 68, four of the bolster blocks 68 are disposed on each corner of the base 28 and the other four bolster blocks 68 are disposed in between the corners of the base 28. The bolster blocks 68 may be attached to the bottom wall 34 and the support wall 32 by conventional means, such as a weld or a mechanical fastener such as a bolt and nut.

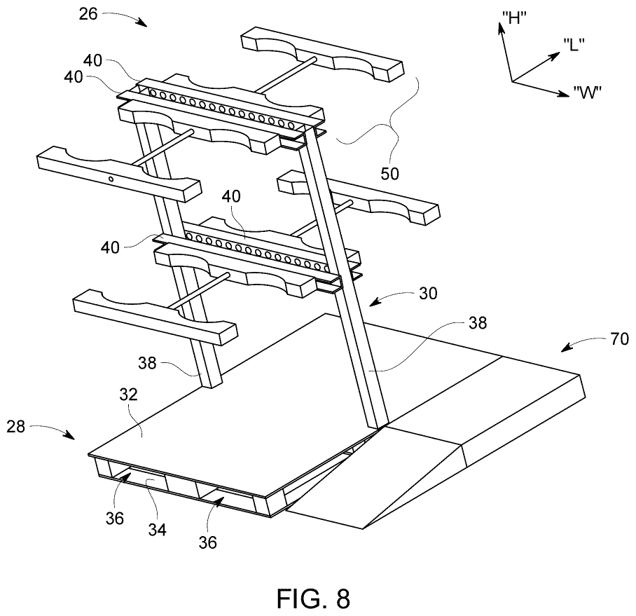

With reference now to FIG. 8, the transport device 26 may further include a ramp 70. The ramp 70 may be formed of a durable and rigid material such as steel or a steel alloy. The ramp 70 may be a standalone unit that may be configured to be positioned adjacent the base 28. The ramp 70 is configured to assist with the placement of a tank 12 onto the base 28.

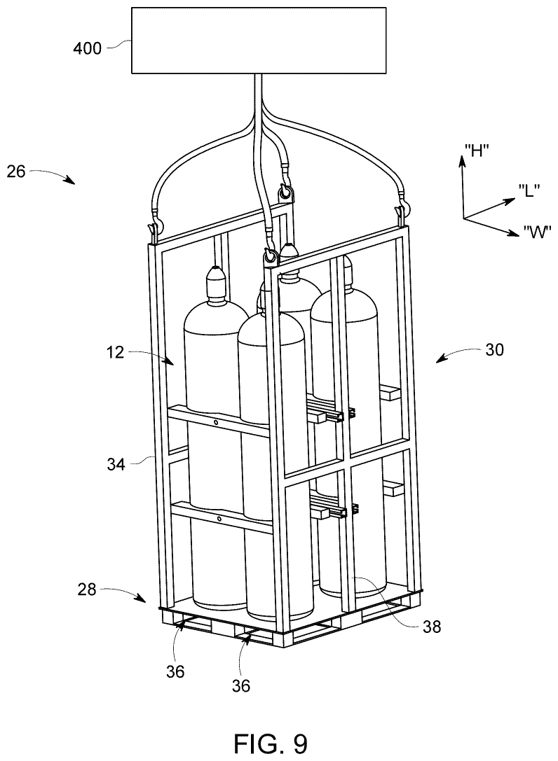

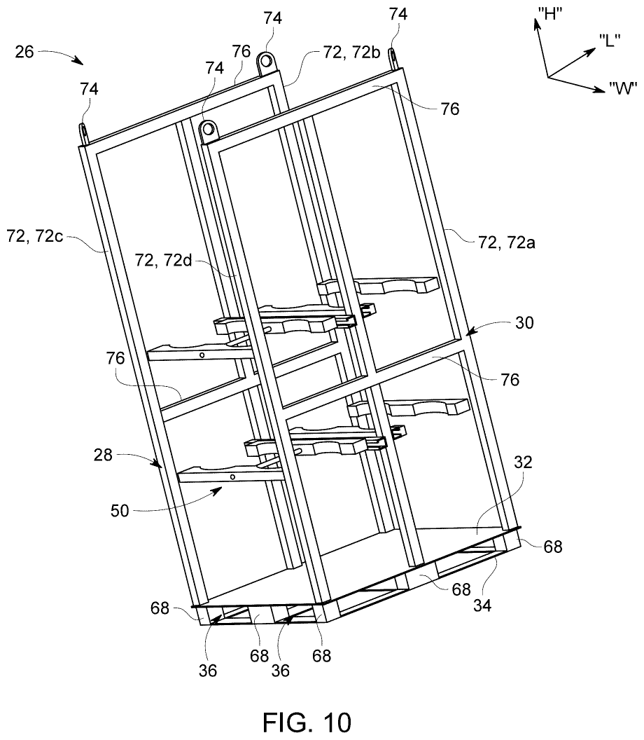

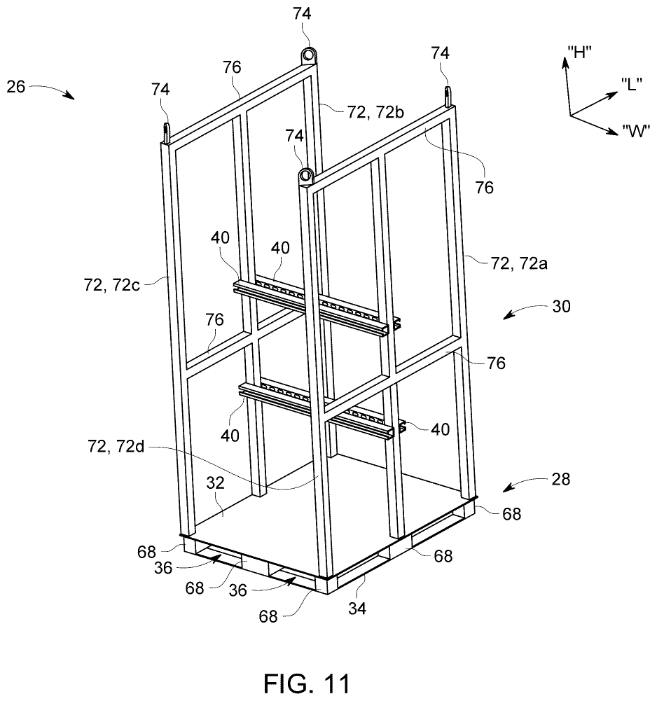

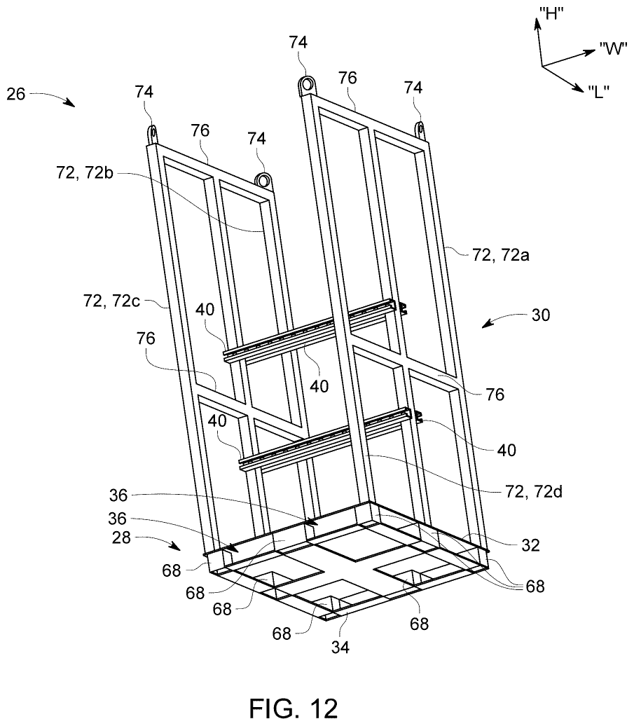

With reference now to FIGS. 9-12, a second aspect of the transport device 26 is provided wherein the transport device 26 may be further configured to be moved by a hoist 400. In this regard, the frame 30 includes a plurality of hoist members 72. The hoist members 72 are elongated bodies formed of a durable and rigid material such as steel or a steel alloy. The hoist members 72 are illustratively shown as bars having a rectangular cross-section with a uniform thickness along its length. However, it should be appreciated that the hoist members 72 may have a circular cross-section. In one aspect, the frame 30 includes a first hoist member 72a, a second hoist member 72b, a third hoist member 72c and a fourth hoist member 72d, each extending from a corresponding corner of the base 28.

A catch 74 is disposed on a top end of each hoist member 72. The catch 74 is configured to be coupled to a hoist 400. In one aspect, the catch 74 may be a closed loop and is disposed on the top end of each of the hoist members 72. The frame 30 may further include a plurality of lateral support members 76 connecting the plurality of hoist members 72 to each other. In one aspect, the frame 30 includes a first lateral support member, a second lateral support member, a third lateral support member and a fourth lateral support member. Lateral support members are elongated bodies formed of a durable and rigid material such as steel or a steel alloy. The lateral support members are illustratively shown as bars having a rectangular cross-section with a uniform thickness along its length.

FIGS. 9-12 depict an aspect where the transport device 26 may be configured to be moved by either a forklift 300 or a hoist 400. For example, the hoist 400 may be configured to be coupled with a corresponding catch 74 so as to lift and carry the transport device 26 from to a shipping vessel and/or from a shipping vessel to a fire suppression system 10. Alternatively, a forklift 300 may be used to move the transport device 26 from to a shipping vessel 500 and/or from a shipping vessel 500 to a fire suppression system 10 by engaging the openings 36.

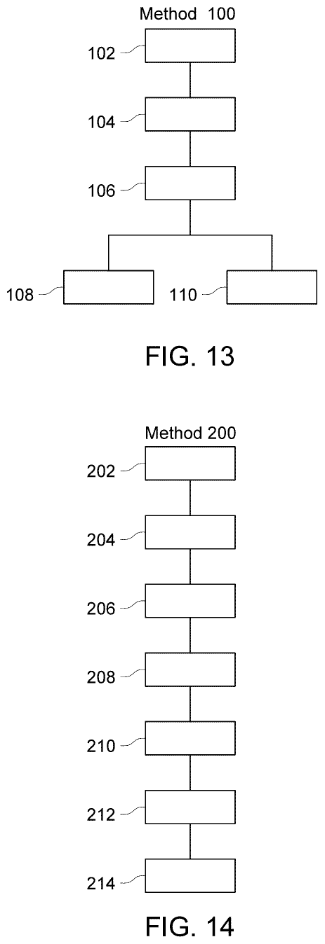

With reference now to FIG. 13, a method 100 of assembling a shipment of tanks 12 is provided. At step 102, the method 100 includes providing the transport device 26 shown in FIGS. 2-12. At step 104, the method 100 includes mounting the plurality of tanks 12 onto the base 28. At step 106, the method 100 includes securing each of the plurality of tanks 12 onto the frame 30 using the holder assembly 50. At step 108, the method 100 includes transporting the transport device 26 with the plurality of tanks 12 onto a shipping vessel 500. The method 100 may further include step 110, wherein the fork 302 of the forklift 300 is inserted into the opening 36 of the base 28 and transporting the transport device 26 with the plurality of tanks 12 onto the shipping vessel 500 using the forklift 300.

Alternatively, the method may include step 110, wherein the frame 30 includes a plurality of hoist members 72, the plurality of hoist members 72 having a catch 74 configured to be coupled to a hoist 400, and transporting the transport device 26 with the plurality of tanks 12 onto a shipping vessel using the hoist 400. As such, the method reduces the physical tasks required to assemble the tanks 12 for transport, by using a dolly to load the tanks 12 onto the transport device 26 and retaining the tanks 12 in an upright position as opposed to laying the tanks 12 on its side and onto pallets.

With reference now to FIG. 14, a method 200 of installing a plurality of tanks 12 to a fire suppression system 10 is provided. The fire suppression system 10 includes a discharge nozzle 16 for discharging a fire suppressant medium, a manifold 20 fluidly connected to the discharge nozzle 16, the manifold 20 having a plurality of intake lines 22 configured to be coupled to a corresponding one of the plurality of tanks 12. A discharge valve 14 and an actuator 18 are coupled to a respective tank 12, wherein the actuator 18 is configured to open the discharge valve 14 so as to release the fire suppressant medium from the tank 12 through the discharge nozzle 16.

At step 202, the method 200 includes providing the transport device 26 shown in FIGS. 2-12. At step 204, the method 200 includes mounting the plurality of tanks 12 onto the base 28. At step 206, the method 200 includes securing each of the plurality of tanks 12 onto the frame 30 using the holder assembly 50. At step 208, the method 200 includes transporting the transport device 26 with the plurality of tanks 12 onto a shipping vessel 500. At step 210, the method 200 includes transporting the shipping vessel to a location where the fire suppression system 10 is housed. At step 212, the method 200 includes unloading the transport device 26 from the shipping vessel 500 at the location of the fire suppression system 10. At step 214, the method 200 includes positioning the transport device 26 adjacent to the manifold 20 and coupling the plurality of intake lines 22 to a corresponding tank 12 as the tanks 12 are held by the transport device 26.

In one aspect, steps 208 and 212 may be performed by a forklift 300, wherein the forks 302 are inserted into the opening 36 of the base 28 and the forklift 300 positions the transport device 26 adjacent the manifold 20.

In one aspect of the method 200, the frame 30 includes a plurality of hoist members 72, the hoist members 72 have a catch 74 configured to be coupled to a hoist 400. In such an aspect, steps 208 and 212 may be performed by the hoist 400, wherein the hoist 400 is coupled to the catch 74 and the hoist 400 is used to position the transport device 26 adjacent the manifold 20.

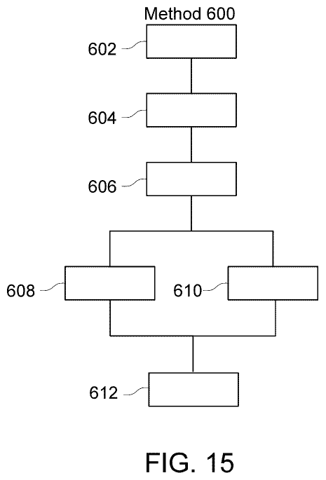

In another aspect, the method 100, 200 may be implemented to facilitate the filling of tanks. With reference now to FIG. 15, a method 600 of assembling a shipment of tanks 12 is provided. At step 602, the method 600 includes providing the transport device 26 shown in FIGS. 2-12. At step 604, the method 600 includes mounting the plurality of tanks 12 onto the base 28. At step 606, the method 600 includes securing each of the plurality of tanks 12 onto the frame 30 using the holder assembly 50. At step 608, the method 600 includes transporting the transport device 26 with the plurality of tanks 12 onto a shipping vessel 500. The method 600 may further include step 610, wherein the fork 302 of the forklift 300 is inserted into the opening 36 of the base 28 and transporting the transport device 26 with the plurality of tanks 12 onto the shipping vessel 500 using the forklift 300.

Alternatively, the method may include step 610, wherein the frame 30 includes a plurality of hoist members 72, the plurality of hoist members 72 having a catch 74 configured to be coupled to a hoist 400, and transporting the transport device 26 with the plurality of tanks 12 onto a shipping vessel using the hoist 400. As such, the method reduces the physical tasks required to assemble the tanks 12 for transport, by using a dolly to load the tanks 12 onto the transport device 26 and retaining the tanks 12 in an upright position as opposed to laying the tanks 12 on its side and onto pallets. At step 612, the method 600 may include transporting the tanks 12 to a filling station, wherein the tanks 12 are moved as a singular unit to the filling station and each tank 12 is filled with a fire suppressant.

As such, the method simplifies the installation of tanks 12 to a fire suppression system 10. In particular, the tanks 12 are held by the transport device 26 in a manner that allows the tanks 12 to be simply moved as a unit into position for coupling with the fire suppression system 10. One benefit is that the tanks 12 are assembled at the distribution site and shipped to the fire suppression system 10 and simply unloaded from the shipping vessel as a singular unit. Thus, the method eliminates the need for a worker to unload tanks 12 on an individual basis and move each tank 12 individually to the fire suppression system 10.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A transport device for transporting at least one tank, the transport device comprising:
a base;
a frame mounted to the base; and
a holder assembly mounted to the frame, wherein the base includes at support wall spaced apart from a bottom wall so as to define an opening configured to receive a fork of a forklift, wherein the support wall is configured to support the at least one tank, and the holder assembly is configured to hold the at least one tank to the frame.

2. The transport device as set forth in claim 1, wherein the bottom wall includes a first elongated member and a second elongated member couped to together to form a cross-shape.

3. The transport device as set forth in claim 1, wherein the frame includes a pair of upright legs spaced apart from each other, and a cross-member extending between the pair of upright legs, and the holder assembly is mounted to the cross-member.

4. The transport device as set forth in claim 1, further including a ramp, the ramp disposed adjacent the base.

5. The transport device as set forth in claim 1, wherein the base and the frame are formed of steel and/or a steel composite.

6. The transport device as set forth in claim 1, wherein the base further includes bolster blocks disposed between the support wall and the bottom wall.

7. The transport device as set forth in claim 3, wherein the cross-member is a pair of cross-members, each of the pair of cross-members having a plurality of slots, wherein the holder assembly is attached to one of the plurality of slots.

8. The transport device as set forth in claim 1, wherein the frame includes a plurality of hoist members, the plurality of hoist members having a catch configured to be coupled to a hoist.

9. The transport device as set forth in claim 8, wherein the catch is a closed loop.

10. The transport device as set forth in claim 9, wherein the plurality of hoist members is four hoist members, each of the hoist members fixed to a corresponding corner of the base.

11. The transport device as set forth in claim 10, wherein the frame includes a plurality of lateral support members connecting the plurality of hoist members to each other.

12. The transport device as set forth in claim 11, wherein the catch is four catches, each disposed on a top end of a corresponding one of the plurality of hoist members.

13. A method of assembling a shipment including a plurality of tanks, the method comprising the steps of:
providing a transport device, the transport device including:
a base;
a frame mounted to the base; and
a holder assembly mounted to the frame, wherein the base includes at support wall spaced apart from a bottom wall so as to define an opening, wherein the support wall is configured to support the at least one tank, and the holder assembly is configured to hold the at least one tank to the frame;
mounting the plurality of tanks onto the base;
securing each of the plurality of tanks onto the frame using the holder assembly; and
transporting the transport device with the plurality of tanks onto a shipping vessel.

14. The method as set forth in claim 13, further including the steps of:
providing a forklift having a fork; and
inserting the fork into the fork into the opening of the base and transporting the transport device with the plurality of tanks onto a shipping vessel using the forklift.

15. The method as set forth in claim 13, wherein the frame includes a plurality of hoist members, the plurality of hoist members having a catch configured to be coupled to a hoist.

16. The method as set forth in claim 15, further including the steps of:
providing a hoist; and
coupling the hoist to the catch and transporting the transport device with the plurality of tanks onto a shipping vessel using the hoist.

17. A method of installing a plurality of tanks to a fire suppression system, the fire suppression system including a nozzle for discharging a fire suppressant medium and a manifold fluidly connected to the nozzle, the manifold having a plurality of intake lines configured to be coupled to a corresponding one of the plurality of tanks, the method comprising the steps of:
providing a transport device, the transport device including:
a base;
a frame mounted to the base; and
a holder assembly mounted to the frame, wherein the base includes at support wall spaced apart from a bottom wall so as to define an opening, wherein the support wall is configured to support the at least one tank, and the holder assembly is configured to hold the at least one tank to the frame;
mounting the plurality of tanks onto the base;
securing each of the plurality of tanks onto the frame using the holder assembly;
transporting the transport device with the plurality of tanks onto a shipping vessel;
transporting the shipping vessel to a location where the fire suppression system is housed;
unloading the transport device from the shipping vessel at the location;
positioning the transport device adjacent to the manifold; and
coupling the plurality of intake lines to the corresponding one of the plurality of tanks as the plurality of tanks are held by the transport device.

18. The method as set forth in claim 17, further including the steps of:
providing a forklift having a fork; and
inserting the fork into the fork into the opening of the base and using the forklift to position the transport device adjacent the manifold.

19. The method as set forth in claim 17, wherein the frame includes a plurality of hoist members, the plurality of hoist members having a catch configured to be coupled to a hoist.

20. The method as set forth in claim 19, further including the steps of:
providing a hoist; and
coupling the hoist to the catch and using the hoist to position the transport device adjacent the manifold.
